(19) United States
(12) Patent Application Publication
(10) Pub. No.: US 2010/0125522 A1
(43) Pub. Date: May 20, 2010

(54) Interactive Web-Portal Interface Method and System

(76) Inventor: Johanny Thomas, Cutler Bay, FL (US)

Correspondence Address: AKERMAN SENTERFITT, P.O. BOX 3188, WEST PALM BEACH, FL, 33402-3188, US

(21) Appl. No.: 12/273,349

(22) Filed: Nov. 18, 2008

(51) Int. Cl. G06Q 20/00

(52) U.S. Cl. 705/44

(57) ABSTRACT

An e-service interactive web-portal providing a method and system that enables consumers to selectively perform point-of-sales (POS) transactions through an e-financial agent which allows payments to be made without having to utilize cash, credit/debit cards or checks, to manage and access electronic personal documents over mobile devices, and to create a virtual/mirror image of a mobile device's stored information (contacts, calendar entries, music, photos, ring tones, etc.) with options to duplicate a mobile device's content onto another device in case of theft, loss or damage, and/or make VoIP phone calls through the virtual mobile device.

### FIELD OF THE INVENTION

The invention relates generally to a web-portal method and system that enables users to perform point-of-sales (POS) transactions and which includes a secure back-up of personal documents, calendar entries and the like.

### BACKGROUND OF THE INVENTION

Currently, existing economic system and POS terminals in the marketplace typically accept only four specific methods of payments for consumer purchases: cash, ATM/debit cards, credit/check cards, and checks. Some POS terminals can also accept smart cards, which are typically embedded on a credit or debit card, but may be supplied on other items, such as a key fob. No payment options or integrated solutions are offered or have been developed that can provide customers with a convenient and flexible method of performing purchases/transactions at POS terminals without having to keep the aforementioned payment items on hand.

If a consumer does not have a payment item to hand, they cannot currently obtain goods or services from a retailer. Loss or theft of a consumer's payment items can be particularly problematic. Not only can the consumer not gain easy access to funds while waiting for replacement cards, but a thief can use the cards.

Similar problems exist with identification cards such as drivers licenses, insurance cards such as health and automobile insurance cards, and the like. If a user's wallet is lost or stolen, they do not have easy access to such documents while waiting for replacements to arrive.

Additionally, current mobile devices such as smart phones, PDA's. Blackberry®, iPhone® and the like involve the storage of a large amount of data such as a calendar, contacts address book, email, and other data. If the mobile device is lost or stolen, or if the user wishes to upgrade to a newer model, it is often difficult to replicate or port the data to a new device. If the user docs not have the data synched with a computer, loss of the mobile device could involve irretrievable loss of data.

It is therefore desirable to have a system which allows a consumer to have online access to payment systems without the need to carry any cards. It is also desirable to allow consumers to be able to save and access their personal information to and from a secure online source, and to be able to access that data from the internet.

### SUMMARY OF THE INVENTION

The present invention relates to an e-service interactive web-portal providing a method and system that enables consumers to selectively perform point-of-sales (POS) transactions through an e-financial agent which allows payments to be made without having to utilize cash, credit/debit cards or checks, to manage and access electronic personal documents over mobile devices, and to create a virtual/mirror image of a mobile device's stored information (contacts, calendar entries, music, photos, ring tones, etc.) with options to duplicate a mobile device's content onto another device in case of theft, loss or damage, and/or make VoIP phone calls through the virtual mobile device.

This integrated platform and e-financial solution also addresses consumer needs for automated processes that provide services such as budgeting and expense tracking. Through this interface, consumers can keep track of expenses, which are automatically organized by categories, allowing access to old records and digital receipts for future reference and possible merchandise returns. The user/consumer can also have the capability to query an individual database interface and obtain a detailed report of all their financial transactions (processed by OPS) indexed by month, year, expense category, merchant name, etc.

The invention is designed to facilitate payment for goods or services without a customer needing to carry a physical payment device. The method involves creating a secure customer profile on a web-based portal, with the profile including links to the customer's bank account and/or credit cards and/or debit cards, providing various payment options. The profile can be created by a user from their own internet connection, and can preferably be linked with an identification verification system, such as a fingerprint scan in the preferred embodiment, although it can be accessible via a pass code alone or by other verification systems, such as, for example, a palm scan or an iris/retina scan. The POS terminal at the retailer or other business can be provided with an option for the customer to select the web-based portal for payment, along with the traditional payment options for debit or credit card, etc. The portal can then be accessed at the POS terminal by the customer by entering a user ID and pass code, and the customer can then select which of their stored payment options they wish to use. If a fingerprint scan is enabled, the customer is then prompted to scan their fingerprint on a USB scanner connected to the POS terminal. The system then validates the identification of the customer, and can process or decline payment to the merchant/service provider accordingly.

The method and system enables customers to be able to pay for goods and services without carrying physical payment means. This can be particularly useful after a person's cards or wallet have been lost or stolen, while the person is waiting for replacements to arrive, or in order to prevent such theft by enabling the person to leave such cards safely at home. If a user wishes to change bank accounts, it is also a simple matter for them to create a link to the new bank account in the web-based portal without needing to wait for the bank to create and send new debit/credit cards. The web-based portal can also be set to store online copies of all transaction receipts, thus enabling a customer to decline a printed receipt for the transaction.

An advantage that this system has over existing business solutions is that it can provide customers with a convenient and flexible method of performing purchases/transactions at POS terminals without having to keep physical methods of payments on-hand. The existing economic system only allows consumer-to-business transactions and/or purchases at merchant POS terminals through the use of cash, ATM/Debit and/or Credit/Check cards, and an Online Point-of-Sales (OPS) method of payment is not presently being offered. The addition of a new method of payment at retailer's POS terminals can offer consumers the freedom to make purchases via the OPS service, which would potentially reduce transactions costs for affiliate business merchants (ABMs).

As a result, the e-service web-portal Online Point-of-Sales (OPS) interface can provide consumers with a highly efficient and convenient payment method and an integrated e-business solution from a central place and under one platform. This simple but sophisticated platform can provide consumers with flexibility and can also improve the customer service approach by emphasizing “customer value proposition” over a secure and centralized platform.

This interface can also offer consumers a fraud alert that can track credit activities such as inquiries, new applications for credit and suspicious transactions through Affiliate Business Partner alliances (i.e. credit bureaus, government agencies, financial institutions, etc.).

The full e-service web-portal can also allow consumers/users to make a positive impact on the environment as they can choose to not have paper receipts printed at the end of their purchase transactions. Through this solution, consumers can no longer require paper receipts to make returns since digital copies of receipts can be kept online and can be linked to each purchase transaction for future access and printing (if needed). The elimination of requiring a receipt at the end of a purchase transaction benefits the customer by allowing them to be more “eco-friendly”; it benefits the merchant as the need for paper and ink for printing such receipts can be decreased, ultimately saving them money. Most importantly, cutting back on consumption and production of paper can significantly reduce the impact these materials have on our environment.

In another embodiment of the invention, users can use the secure web-based portal to create a safe repository for other personal information in addition to their financial information. This may include scanned copies of driver's licenses, social security cards, etc., or in a preferred arrangement the web-based portal can link to other online databases, such as a government driving license database, to provide a live view of the user's documents. A live view of the user's documents may include a visual representation of the document, such as a driver's license or social security card, or may include a link to the user's records. In a preferred arrangement, a user can also upload data from a personal device such as a Blackberry, Smart phone, etc., allowing storage of their calendar, address book, photos, music and other mobile applications. The system can also allow a user to connect in to the portal and use their profile to make VoIP telephone calls in the event that their mobile device is inaccessible, lost or stolen.

A primary advantage for using this service is for prevention of theft and loss of personal documents. A person's identity is stolen every day as a result of loss or misplacement of personal documentation such as a driver's license, social security card, credit cards, checkbooks, etc. A consumer may lose a wallet on more than one occasion and may never recover it. If someone else recovers a lost/stolen wallet, that person can establish an identity with the victim's personal information by opening accounts under the victim's name, as well as utilizing the victim's credit cards. Meanwhile, the individual who has lost the wallet is forced to spend countless hours calling creditors in order to cancel credit/check cards, and waiting to have new ones issued. Often times, bank accounts have to be closed and reestablished and alerts need to be placed on credit bureaus to prevent thieves from damaging a victim's credit history, which most of the time cannot be repaired. On top of this, a new copy of a driver's license and social security card must be obtained, which in turn represents many hours spent waiting in line, on the phone, and then having to pay fees for duplications or reissue of documents. By having a secure online repository, the user does not need to carry their original documents with them, and a copy can be easily viewed in the case of a lost or stolen document.

Through the repository service, users can conveniently and effortlessly retrieve electronic personal documents (including Driver's License, Social Security card, etc.) through their mobile device. These documents can be retrievable from an interface linked to ABP intranets (i.e. governmental agencies such as Department of Transportation, Social Security Administration and Passport Agency; and insurance companies, etc.). The documents can be formatted to display either an image that matches the size of a physical Driver's License, etc., or can display an enlarged image that matches the size of the mobile device screen.

A further embodiment of the invention involves creating and retrieving a back-up/mirror image of a mobile device such as a cellphone, smart phone, etc. Users can access the mirror version of their mobile device's content via a virtual mobile in the event of accidental loss, damage, theft, etc. of physical mobile device. The virtual unit can be accessed from anywhere in the world through a web-browser which can contain all information stored in their mobile device (including address book, calendar, mobile applications, etc.). The user can have the option to have the exact copy of the information duplicated onto another device.

Furthermore, in the event a user's phone has been lost, stolen, misplaced or is left uncharged, user can have the ability to make VoIP phone calls through their virtual e-mobile device. This service feature can simulate phone calls usually made from the user's mobile device except that it can be made from the e-Service portal through the virtual mobile device by dialing a toll free number via a regular landline phone or through a personal computer (requires VoIP headset).

### BRIEF DESCRIPTION OF THE DRAWINGS

Further objectives and advantages of the invention can become more apparent from the following description and claims and from the accompanying drawings herein.

FIG. 1 shows a flow chart of an e-service portal consumer-to-business processes.

FIG. 2 shows a flow chart of a consumer process.

### DETAILED DESCRIPTION OF THE EMBODIMENTS OF THE INVENTION

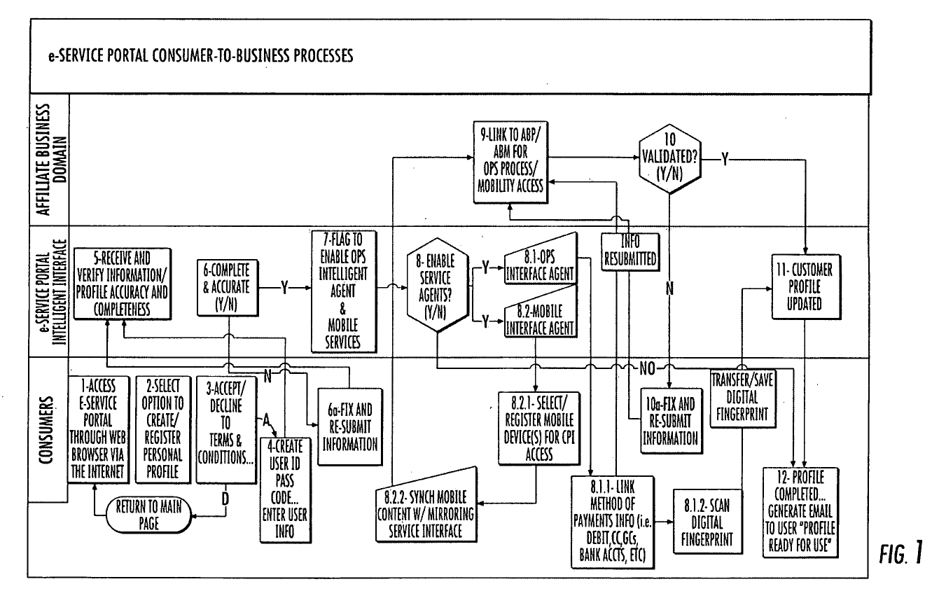

With reference to FIG. 1, an e-Service portal consumer-to-business process flowchart is shown. This portal enables users to sign up and create a profile in order to use the system and method of the present invention.

The e-Service (software/internet technology) web-portal with an intelligent “consumer-to-business” interface can allow users/consumers to make retail purchases through an Online Point-of-Sales (OPS) system that does not require the use of standard methods of payments such as cash, ATM/Debit cards, credit cards checks, etc. This interface can be connected with ABPs (Affiliated Business Partners—i.e. financial institutions, credit card companies) that can authorize the online point-of-sales purchases, and ABMs (Affiliated Business Merchants—i.e. grocery stores, retail stores, pharmacies, etc.) that can accept Online Point-of-Sales purchases at their locations.

At step 1, a user can access the e-Service portal through a secure web-browser (for example Opera, Safari, IE, Firefox) on their personal computer to register as a member and create a consumer personal profile (CPP). At step 2, the user can select an option to create/register a personal profile. At step 3, the user can accept or decline “Terms and Conditions”; if accepted, then personal profile form can load. If the “Terms and Conditions” are not accepted, user can be directed back to the homepage.

After a user has accepted the “Terms and Conditions” and a personal profile form has loaded, the user can create a unique User ID and a Pass Code at step 4. The Pass Code is typically 4-8 digits, but any suitable code can be used. During this step, the user can also enter their personal information (i.e. name, address, city, state, zip, etc.). At step 5, the e-Service portal can receive and verify the information/profile for accuracy and completeness. If the user's information is complete and accurate, the interlace can process the data and create a profile in step 6. If the information is not accurate, the form can load again to give the user opportunity to correct the information in step 6a.

Once the user's information has been verified, the user can be provided with a customer value proposition of enabling the Online Point-of-Sales (OPS) Intelligent Agent and Mobile Services, at step 7. The user can at this point select whether or not to enable services (step 8).

If the user selects not to enable services (step 8.1), the user's profile can be created with personal information already provided by the user and the process is complete (step 12). If, however, the user chooses to enable one of the services, the user can be prompted to enter information only for the service selected (either OPS or Mobility) or for both services.

If the user selects to use the OPS service by selecting the appropriate choice on the interface (step 8.1), at step 8.1.1 the user can be asked to link the desired methods of payment (CC, debit, bank accounts, gas card, etc.) to the profile. Meanwhile, the intelligent agent (in the background) can associate/link the user/consumer profile to the Affiliate Business Merchant list of registered retailers to accept online payments. Credit cards and bank information can be validated by the ABP (financial institution and/or credit card company) in order to enable processing of online payments. Once the user has entered and linked the payment information and it has been authenticated by the ABP the portal intelligent interface agent can, at step 8.1.2 require the user to register at least one biometric identifier for payment authentication via a USB digital fingerprint scanner. The biometric identifier can be a digital fingerprint scan, a palm scan, an eye (iris/retina) scan, or any other suitable identifier. The system interface can process the digital fingerprint (or other identifier) and can associate it with the user's profile (step 11) for transaction approval/security authentication at POS terminals at the time of making purchases.

If the user selects to use the Mobility interface agent (step 8.2), the user can have the option to register mobile devices in order to retrieve personal information from their personal profile via wireless/Wi-Fi (which can be displayed as a screen capture), as well as to create a mirror image of the phone's content for online access and backup/restore purposes in the event of accidental loss, damage, theft, etc. At step 8.2.1, users can select their phone model and type from a list of virtual mobile devices available in the market and associate their SIM cards (subscriber identity module which is a smart card that securely stores the key identifying a mobile phone service subscriber, as well as subscription information, preferences and text messages) to the virtual phone they have selected, which can allow wireless/Wi-Fi communication between the mobile interface and the mobile device. Through this interface mobile option, users can also have the capability to access their virtual unit from anywhere in the world through a web-browser allowing access to their phone's address book, calendar, mobile applications, etc.; this can also be available by dialing a landline designated number to make VoIP calls (charged against their wireless carrier's phone bill). At step 8.2.2, the mobile device content can be synchronized (wirelessly) with the mirroring service interface. The user's profile information is validated by ABP/ABM for OPS processing and mobility service access in step 9 after the steps in #8 have been completed.

The information can then be validated or declined by ABP/ABM in step 10. If ABP/ABM declines the user's information (for example, invalid credit card number, expired credit card, insufficient bank funds, etc.) the user can be prompted to reenter and resubmit (step 10a). If the user's methods of payment associated with their customer profile are validated by ABP/ABM (financial institutions, CC companies, etc.) ABP/ABM system interface can forward acknowledgement to e-Service portal that methods of payment arc valid and ABP/ABM can be ready to accept/process OPS transactions (step 10b). The methods of payment are then officially associated with customer's profile based on ABP/ABM's approval at step 11.

The profile is complete (step 12). An email can be generated to advise user that OPS and/or Mobility Service options have been enabled and are ready for use.

In the ABP/ABM (affiliate business partner/affiliate business merchant) function area, all registered businesses can be linked to the e-Service portal through an interface that verifies user methods of payments and processes all transactions from OPS at any participating POS terminal location. Affiliate business partners (ABPs) can include, but can not be limited to local banks (i.e. Citi, Wachovia, Washington Mutual, SunTrust, etc.), internet banks, credit card companies, and other payment systems companies; ABMs can include discount stores (i.e. Wal-Mart, Target, Kmart, Sears, etc.); clothing chains (i.e. Old-Navy, Polo, GAP, Payless Shoes, etc.); grocery/retail stores (i.e. Publix, Winn-Dixie, Sedanos, Hallmark, etc.); pharmacies (CVS, Walgreen's, Navarro Discount, etc.), and restaurants. The invention is not limited in this regard.

Users can perform their regular purchases through any of these participating vendors by selecting OPS at the POS terminal and the ABP can recognize consumer transactions since their POS systems can be linked and interfaced with the portal.

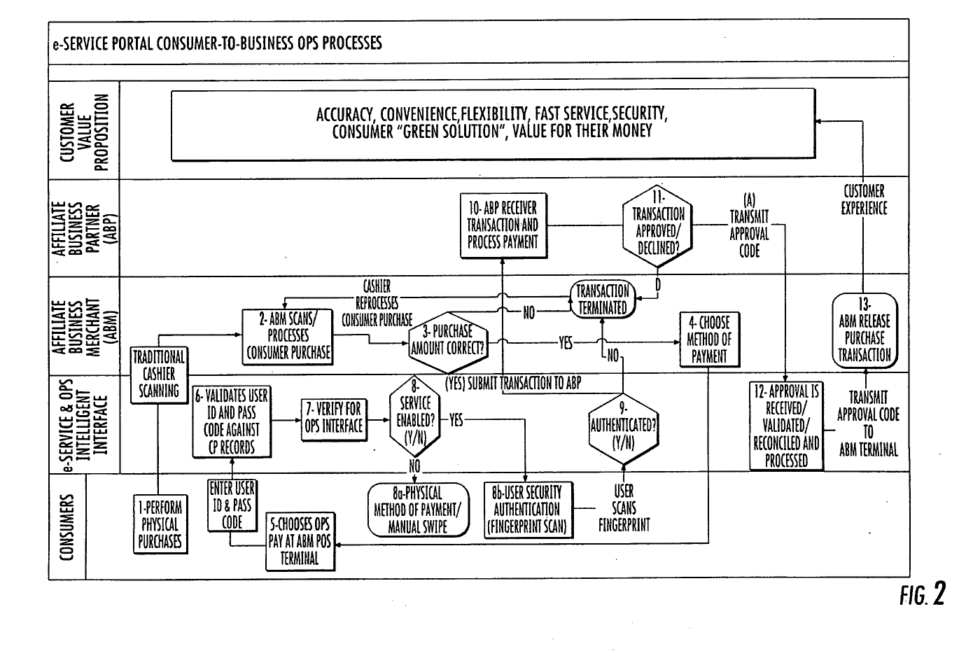

With reference to FIG. 2, a consumer process flowchart is shown. This illustrates use of the e-Service with POS transactions carried out at a vendor.

At step 1, a consumer visits an Affiliated Business Merchant (ABM) and performs a physical purchase by taking all items to be purchased to a register. At step 2, the ABM cashier scans the items at the register and processes the consumer's purchase total. Once the cashier processes the purchase total, the consumer is prompted to acknowledge if the total purchase amount is correct at a POS terminal (step 3). If the consumer declines the amount, the transaction is terminated. The cashier must then reprocess the total and the consumer can have the opportunity to once again accept the amount.

If the consumer accepts the purchase amount, the consumer can be prompted to choose a method of payment at the ABM's POS terminal (step 4). The consumer can select OPS as the method of payment at the POS terminal (step 5).

The e-service and OPS system is contacted by the POS terminal, and the consumer is then prompted to enter their User ID & Pass Code. The e-Service interface validates the User ID & Pass Code against the user's profile on record (step 6).

The interface verifies the consumer's information and can continue with processing if OPS service is enabled (steps 7 and 8). If OPS service is not enabled, the consumer can be prompted on the POS terminal to select a physical method of payment to complete the purchase (step 8a). If OPS service is enabled, the user can be prompted to scan their fingerprint (USB) on a scanner that is directly connected to the POS terminal (step 8b). Of course, if another biometric identifier, such as a palm print, is connected to the user's account, and/or a palm scanner is connected to the POS terminal, the user is prompted as appropriate, in place of a fingerprint scan.

Interface can then proceed with authentication of the consumer's fingerprint or other biometric identifier (step 9). If the fingerprint or other identifier is not authenticated, the transaction can be terminated. If the fingerprint is authenticated, the transaction can be received by the ABP (bank or credit card company, etc.) for processing/transaction authorization. The ABP receives the transaction and proceeds with processing/authorizing of the payment (step 10). The ABP can approve or decline the transaction (step 11). If the transaction is declined (i.e. insufficient funds, CC balance over limit, invalid/expired CC, etc.), the transaction can be terminated. If the transaction is approved, an approval code can be transmitted to the e-Service interface.

Once the approval is received, validated, reconciled and processed by the e-Service interface (step 12) against the consumer's profile, an approval code is sent to the ABM's POS terminal. The purchase is then completed at the ABM (step 13).

The POS interface provides flexibility and great convenience while being an innovative business solution for users/consumers, as point-of-sale payments can be conducted with ease (without cash, checks, ATM/Debit/Credit Cards) via a highly secured web-portal which is backed up by a digital fingerprint scanning technology security feature or other biometric identifier.

Since the task of paying online is done through portal intelligent service agents and through interfaces associated with financial institutions and Affiliate Business Merchants (ABMs), users/consumers can no longer have to pay with physical methods of payment, which means freedom from having to carry cash, credit cards, checks, etc.).

Finally, this e-Service portal solution can comply with the standardization body FIPA (IEEE Foundation for Intelligent Physical Agents), which can allow for a flexible, convenient and integrated platform that can increase the interoperability between systems (e-Service portal, financial institutions, and Affiliate Business Merchant).

The e-Service portal also allows the user to create a repository for various personal documents and identification documents. Through this service, users can retrieve personal information (including digitalized versions of their driver's license. Social Security card, insurance card, and any other important information that has been stored) from their personal profile via wireless/Wi-Fi. The documents can be retrievable from an interface linked to ABP intranets (i.e. governmental agencies such as Department of Transportation, Social Security Administration and Passport Agency; and insurance companies, etc.). The documents can be formatted to display either an image that matches the size of a physical Driver's License, etc., or can display an enlarged image that matches the size of the mobile device screen.

The e-Service portal additionally can provide mobile mirror imaging service which allows users/consumers to register mobile devices, where they can be granted access to a mirroring solution that can allow them to create a mirror/duplicate version of their mobile devices for online access and backup/restore purposes in the event of accidental loss, damage, etc. Users can also access their virtual unit from anywhere in the world through a web-browser allowing access to their device's address book, calendar, mobile applications, etc. Furthermore, users can have the ability to make VoIP calls when their mobile device is inaccessible or in the event the user would like to make a long-distance call utilizing their mobile's network infrastructure instead of having to make call via a local landline.

The repository service and the mirroring service are enabled only if user/consumer registers and has chosen to enable the intelligent service interface for mobility services after they have created their personal information profile.

After a user has registered and opted to enable service, the user can select their phone/mobile device model and type from a list of virtual mobile devices available in the market and associate their SIM cards to the virtual phone they have selected, which can allow wireless/Wi-Fi communication between the mobile interface and the mobile device. Mobile device content can then be synchronized with mirroring service interface.

The mirroring service for wireless devices is synchronized over wireless/Wi-Fi network and can be an exact replica of the users/consumers mobile device (in a digital version). The information stored can be transferable to other devices (also wirelessly) selected by the user via the portal (i.e. device model, vendor/brand, etc.). This function can be advantageous for users/consumers in the event of loss of a phone/smart device. The users/consumers can simply replace the unit (through their carriers) for a new unit and then they can access the portal and download/re-synch the information stored on record (i.e. contacts, calendar, pictures, music, etc.). As a result, the users/consumers can not have the need to enter contacts and information all over again into their replaced device.

Mobile devices can have a mini Internet browser that can be specifically designed to allow secure access to the e-Service web portal interface. Once the user accesses the portal through their mini browser, they can enter user ID and pass code. The system can authenticate user ID/pass code granting access to a user's personal profile. The user can have ability to select a document they would like to retrieve from an interface linked to ABP intranets (i.e. governmental agencies such as Department of Transportation, Social Security Administration and Passport Agency; and insurance companies, etc.) and have it shown on their mobile device's screen for either reference or identification purposes. This interface may either download the document to the user's mobile device, or may show a live screenshot that is not saved to the device.

This platform addresses the problem of potential identity theft since users/consumers can no longer need to carry credit cards/ATM/debit cards and personal documents, etc., to complete purchases and retail transactions. Information such as DL, SS, and other personal documentation is digitized and can be accessible over wireless device(s) giving users/consumers a convenient way to obtain their information from their digital devices on demand. The information is never downloaded to the device; it is only accessed/snapped on the screen (for security purposes, in case the device is lost or stolen) and can only be made available through the specific registered device(s) assigned by the users/consumers when they established an account.

Users can also have the option to access their virtual mobile device and its content through a regular landline by simply calling a designated number and entering their user ID/pass code in order to make a VoIP call. Once the user ID/pass code is authenticated, a voice recognition feature can allow the user to search through a list of contacts on their mobile device—for example, the user can specify the name of a contact and the system can read back the phone number (in event a contact has more than one phone number, system can indicate all numbers available for that contact, and user can have ability to choose the correct number). After the contact's phone number has been selected, user can instruct the system to dial the number. The phone number can be dialed and bridged in through the use of VoIP technology. This service feature can simulate phone calls usually made from the user's mobile device except that it can be made from the e-Service portal through a virtual mobile device by dialing a toll free number via a regular landline phone or through a personal computer (requires VoIP headset). These calls can be billed through mobile service carrier.

Further modifications and alternative arrangements of various aspects of the invention can be apparent to those skilled in the art in view of this description. Accordingly, this description is to be construed as illustrative only and is for the purpose of teaching those skilled in the art the general manner of carrying out the invention.

It is to be understood that the forms of the invention shown and described herein are to be taken as the presently preferred arrangements. Elements and materials may be substituted for those illustrated and described herein, parts and processes may be reversed, and certain features of the invention may be utilized independently, all as would be apparent to one skilled in the art after having the benefit of this description of the invention. Changes may be made in the elements and compositions described herein or in the features or in the sequence of features of the methods described herein without departing from the spirit and scope of the invention as described in the following claim(s).

1. A method for providing a repository for personal information and for processing financial transactions, comprising the steps of:
creating a secure user profile on a web-based portal, the profile including links to at least one of the user's bank account, credit cards, and debit cards;
linking the secure user profile with an identification verification system such that a user can enter identifying information that is attached to the secure user profile;
allowing the user to upload or link selected data and information to the secure user profile to provide a web-based repository of at least one of calendar data, contacts data, personal identification data and documents, email, messages, music, images, movies, mobile telephony accounts and settings;
providing a point of sales terminal at a physical vendor, or providing a web-based link or payment option at an online vendor, the point of sales terminal or payment option link having an option for the user to select the web-based portal as a payment option, and having a link to the identification verification system such that the user can access their secure user profile;
allowing the user to select which of their stored payment options they wish to use to provide payment; and
validating the identification of the user with the identification verification system, and if the user's identification is validated, approving transfer of funds from the user's selected stored payment option to the vendor.

2. The method according to claim 1, wherein the method further includes generating an electronic receipt upon payment to the vendor and storing an online copy of the receipt in the secure user profile.

3. The method according to claim 1, wherein the identification verification system includes a scan of the user's fingerprint or palm, and wherein a fingerprint or palm scanner is provided with the physical point-of-sales terminal or a fingerprint or palm input is provided with a web-based payment option link such that the user scans their fingerprint or palm at the time of accessing their secure user profile.

4. The method according to claim 1, wherein the secure user profile includes data relating to a user's mobile telephony provider such that a user can connect to the portal and use their profile to make VoIP telephone calls.

5. The method according to claim 1, wherein the user can upload a data backup of a mobile device to their secure user profile, and can selectively download the backup data or transfer portions of the backup data to a different mobile device.

6. The method according to claim 1, wherein the user can view images of personal documents on a mobile device or other computer in order to provide identification verification or proof of insurance to a third party, the personal documents being at least one of previously uploaded to the repository service, and retrievable from an interface linked to a separate document database.

7. A system comprising a computer-readable web-based repository for personal information and for processing financial transactions, comprising:
a secure user profile on a web-based portal, the profile including links to at least one of the user's bank account, credit cards, and debit cards, such that the user can process payments to vendors through the secure user profile;
an identification verification system such that a user can enter identifying information that is attached to the secure user profile to only allow access to specified users;
personal data and information uploaded or linked by the user to the secure user profile to provide a web-based back-up of at least one of calendar data, contacts data, personal identification data and documents, email, messages, music, images, movies, mobile telephony accounts and settings.

8. The system according to claim 7, wherein the identification verification system includes a scan of the user's fingerprint or palm.

9. The system according to claim 7, wherein the secure user profile includes data relating to a user's mobile telephony provider such that a user can connect to the portal and use their profile to make VoIP telephone calls.

10. The system according to claim 7, wherein the user can upload a data backup of a mobile device to their secure user profile, and can selectively download the backup data or transfer portions of the backup data to a different mobile device.

11. The system according to claim 7, wherein the user can view images of personal documents on a mobile device or other computer in order to provide identification verification or proof of insurance to a third party, the personal documents being at least one of previously uploaded to the repository service, and retrievable from an interface linked to a separate document database.
